(19) United States
(12) Patent Application Publication
(10) Pub. No.: US 2024/0350905 A1
(43) Pub. Date: Oct. 24, 2024

(54) FORCE SENSATION PRESENTATION DEVICE

(71) Applicant: SONY INTERACTIVE ENTERTAINMENT INC., Tokyo (JP)

(72) Inventor: MORIO KAKIUCHI, Tokyo (JP)

(21) Appl. No.: 18/713,159

(22) PCT Filed: Dec. 10, 2021
(86) PCT No.: PCT/JP2021/045523

§ 371 Date: May 23, 2024

(51) Int. Cl. A63F 13/285

(52) U.S. Cl. CPC A63F 13/285

(57) ABSTRACT

A force sensation presentation device 10 is worn around the neck of a user. A communication section 32 receives a control signal from an external device. A first force sensation presentation section 34a and a second force sensation presentation section 34b each include an actuator and a movable part driven by the actuator, and present a force sensation to the user wearing the force sensation presentation device 10. A control section 30 controls the actuator according to the received control signal.

### TECHNICAL FIELD

The present invention relates to a device that is worn around the neck of a user to present a force sensation to the user.

### BACKGROUND ART

PTL 1 discloses a wearable device that includes a left speaker, a right speaker, a coupler for connecting the left speaker and the right speaker to each other and is worn around the neck of a user. The left speaker and the right speaker each include an audio output unit and a tactile presentation unit. The tactile presentation unit includes a vibration device for generating vibrations, and is driven by a tactile signal for tactile presentation.

### CITATION LIST

### Patent Literature

[PTL 1]
PCT Patent Publication WO2021/044901

### SUMMARY

### Technical Problem

A wearable device is attached to the user's body, and thus has the potential to provide a user with various kinds of sensations.

Accordingly, an object of the present invention is to provide a wearable device that presents the force sensation to a user.

### Solution to Problem

In order to solve the above problem, according to an aspect of the present invention, there is provided a force sensation presentation device that is worn around a neck of a user. The force sensation presentation device includes a communication section, a force sensation presentation section, and a control section. The communication section receives a control signal from an external device. The force sensation presentation section presents a force sensation to the user wearing the force sensation presentation device and includes an actuator and a movable part. The movable part is driven by the actuator. The control section controls the actuator according to the received control signal.

### BRIEF DESCRIPTION OF DRAWINGS

FIG. 1 is a diagram illustrating an example of a configuration of a game system according to an embodiment.

FIG. 2 is a diagram illustrating a force sensation presentation device that is worn around the neck of a user.

FIG. 3 is a perspective view of the force sensation presentation device.

FIG. 4 is a top view of the force sensation presentation device.

FIG. 5 is a diagram illustrating an example of a structure of a first adjustment section.

FIG. 6 is a diagram illustrating functional blocks of the force sensation presentation device.

FIG. 7 is a schematic diagram illustrating a structure of a force sensation presentation section.

### DESCRIPTION OF EMBODIMENT

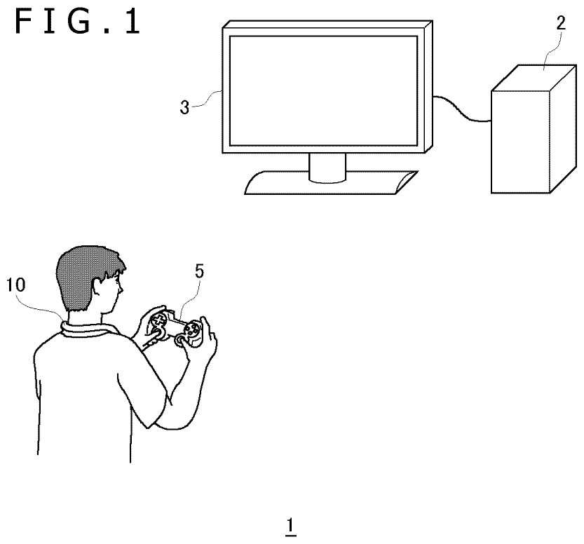

FIG. 1 illustrates an example of a configuration of a game system 1 according to an embodiment. The game system 1 includes a game console 2, an output device 3, a game controller 5, and a force sensation presentation device 10. The output device 3 outputs game images and game sounds. The game controller 5 is operated by fingers of a user. The force sensation presentation device 10 is worn around the neck of the user. In the game system 1, the game console 2 is cable-connected to the output device 3, and wirelessly connected to the game controller 5 and the force sensation presentation device 10. It should be noted that the game console 2 may be wirelessly connected to the output device 3, and may be cable-connected to the game controller 5 and the force sensation presentation device 10.

The game console 2 executes game software and performs arithmetic processing to move a player character in a three-dimensional virtual space according to operation information inputted to the game controller 5. The game console 2 generates game images and game sounds that describe the progress of a game, and outputs the game images and the game sounds from the output device 3. The output device 3 may be a television, or may be a virtual reality (VR) device such as a head-mounted display. It should be noted that an imaging device for capturing images of the user may be disposed near the output device 3.

The force sensation presentation device 10 is worn around the user's neck and presents a force sensation (force sense) around the user's neck. In addition to the function of presenting the force sensation to the user, the force sensation presentation device 10 according to the embodiment has a function of presenting a tactile sensation (touch sense, tactile sense) to the user and a function of outputting sounds. In the embodiment, the tactile sensation is a skin sensation that is felt when a person touches a surface of an object, and is indicative of a sensation primarily perceived by skin receptors. Meanwhile, the force sensation is a reaction force sensation that is felt when a person comes into contact with an object, and is indicative of a sensation primarily perceived by receptors located deeper than the skin.

In the game system 1, the game software generates a control signal for controlling the force sensation presentation device 10, according to the progress of a game. While the user is playing the game, the force sensation presentation device 10 presents the user with a force sensation based on the progress of the game according to the control signal. This increases the user's sense of immersion in the game. As described above, the force sensation presentation device 10 has a tactile presentation function and a sound output function in addition to a force sensation presentation function. This makes it possible to provide the user with various kinds of experiences during a game play.

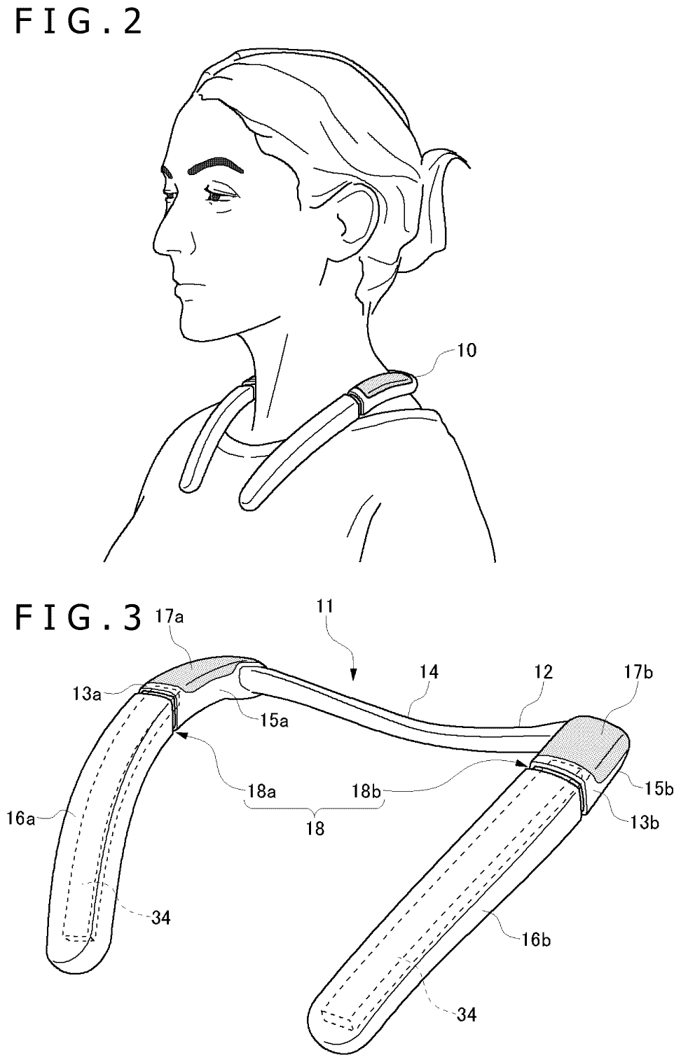

FIG. 2 illustrates the force sensation presentation device 10 worn around the user's neck.

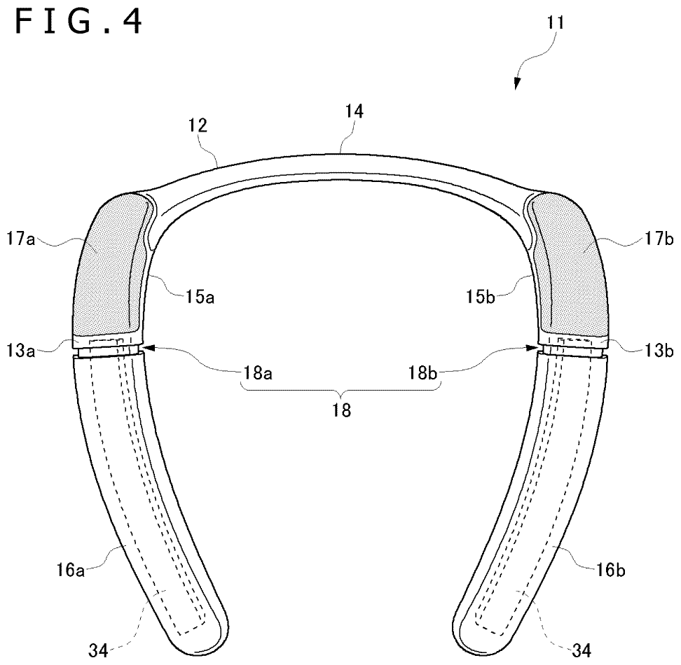

FIG. 3 is a perspective view of the force sensation presentation device 10. FIG. 4 is a top view of the force sensation presentation device 10. The force sensation presentation device 10 includes a main body 11 that forms a housing for the force sensation presentation device 10. The main body 11 includes a base section 12, a first extended section 16a, and a second extended section 16b. The first extended section 16a is connected to a first end 13a of the base section 12. The second extended section 16b is connected to a second end 13b of the base section 12. When the first extended section 16a and the second extended section 16b are not particularly distinguished from each other, they are referred to as “extended sections 16.” A force sensation presentation section 34 is disposed inside a housing for each of the extended sections 16 to present a force sensation to the user.

The base section 12 includes a curved section 14, a first overhang section 15a, and a second overhang section 15b. The curved section 14 contacts the back of the user's neck. The first overhang section 15a and the second overhang section 15b overhang forward from both ends of the curved section 14, respectively. The ends of the first overhang section 15a and the second overhang section 15b form the first end 13a and the second end 13b of the base section 12, respectively. A first speaker 17a and a second speaker 17b are disposed on the first overhang section 15a and the second overhang section 15b, respectively. While the user is playing the game, the first speaker 17a and the second speaker 17b may output a game sound different from the game sound outputted by the output device 3. In such an instance, the game console 2 generates the game sound to be outputted from the output device 3 and the game sound to be outputted from the first speaker 17a and the second speaker 17b. The first speaker 17a and the second speaker 17b may output the sound of conversation with other users.

The main body 11 is substantially U-shaped when viewed from above. When the user wears the force sensation presentation device 10, the curved section 14 of the base section 12 contacts the back of the user's neck, and the first overhang section 15a and the second overhang section 15b each contact the side of the user's neck near the user's shoulder. The first extended section 16a is extended from the right side of the user's neck to the vicinity of the chest, and the second extended section 16b is extended from the left side of the user's neck to the vicinity of the chest. Eventually, the first extended section 16a and the second extended section 16b come into contact with the upper body including the front of the user's neck. It is preferable that the front ends of the first extended section 16a and the second extended section 16b be each disposed at a position beyond the clavicle (a position below the clavicle). When worn around the user's neck and brought into contact with the back, sides, and front of the user's neck, the force sensation presentation device 10 stably fits around the user's neck and provides good wearability.

The force sensation presentation device 10 includes an adjustment mechanism 18 that is able to adjust the length of the main body 11. The adjustment mechanism 18 according to the embodiment includes a first adjustment section 18a and a second adjustment section 18b. The first adjustment section 18a is able to change the position of the first extended section 16a relative to the base section 12. The second adjustment section 18b is able to change the position of the second extended section 16b relative to the base section 12.

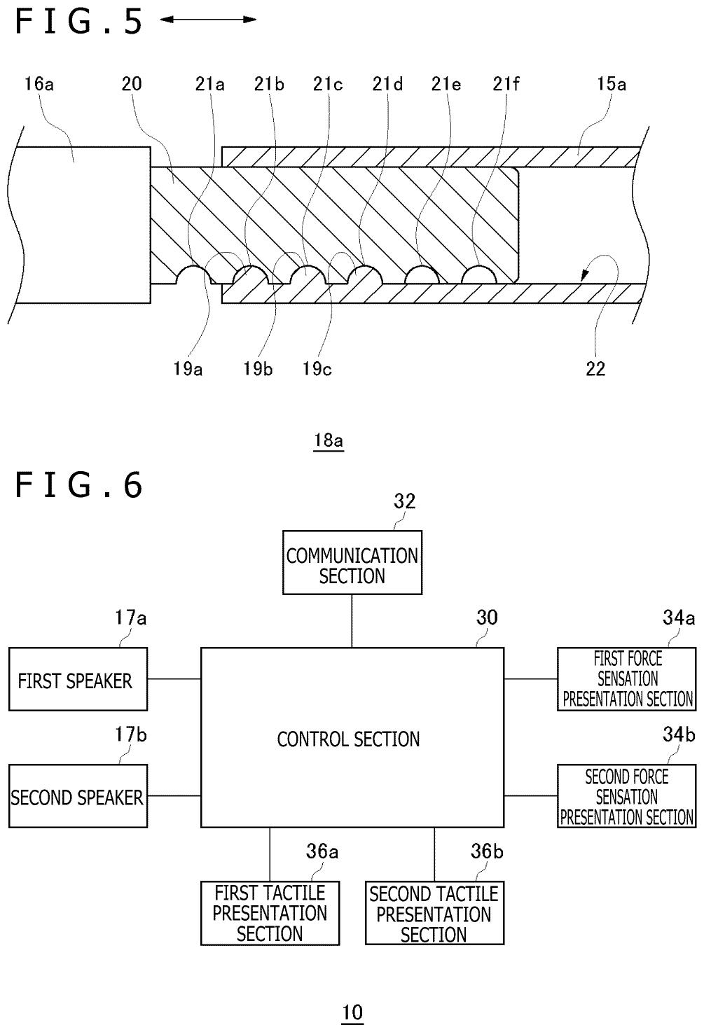

FIG. 5 illustrates an example of a structure of the first adjustment section 18a. The first adjustment section 18a includes an arm 20 that is fixed to the base of the first extended section 16a. The arm 20 is inserted into a cylindrical body section 22 formed on the first overhang section 15a. A plurality of recesses 21a to 21f are formed continuously at equal intervals on one surface of the arm 20. A plurality of engaging protrusions 19a to 19c are formed continuously at equal intervals on a surface of the cylindrical body section 22 that is opposite the above-mentioned surface of the arm 20. The arm 20 is allowed to slide inside the cylindrical body section 22 when the cylindrical body section 22 elastically deforms. The length between the first extended section 16a and the first overhang section 15a can be changed by engaging the recesses 21 with the engaging protrusions 19 at an appropriate position. In the example of the structure illustrated in FIG. 5, the elasticity of the cylindrical body section 22 is utilized. However, the engaging protrusions 19 may alternatively be formed as spring members to allow the arm 20 to slide inside the cylindrical body section 22.

The second adjustment section 18b may have the same structure as the first adjustment section 18a. It should be noted that the structure of the first adjustment section 18a illustrated in FIG. 5 is merely an example. Alternatively, the arm 20 may be fixed to the first overhang section 15a and inserted into a cylindrical body section formed in the first extended section 16a. In any case, the first adjustment section 18a may have a different structure for changing the length between the first extended section 16a and the first overhang section 15a.

FIG. 6 illustrates functional blocks of the force sensation presentation device 10. The force sensation presentation device 10 includes a control section 30, a communication section 32, the first speaker 17a, the second speaker 17b (when the first speaker 17a and the second speaker 17b are not particularly distinguished from each other, they are simply referred to as “speakers 17”), a first force sensation presentation section 34a, a second force sensation presentation section 34b (when the first force sensation presentation section 34a and the second force sensation presentation section 34b are not particularly distinguished from each other, they are referred to as “force sensation presentation sections 34”), a first tactile presentation section 36a, and a second tactile presentation section 36b (when the first tactile presentation section 36a and the second tactile presentation section 36b are not particularly distinguished from each other, they are referred to as “tactile presentation sections 36”). In the embodiment, the first force sensation presentation section 34a and the first tactile presentation section 36a are disposed inside a housing for the first extended section 16a, and the second force sensation presentation section 34b and the second tactile presentation section 36b are disposed inside a housing for the second extended section 16b. A battery (not depicted) supplies electrical power to each of the above-mentioned component elements.

The communication section 32 receives the control signal from the game console 2, which is an external device.

According to the control signal, the control section 30 controls the operation of each component element included in the force sensation presentation device 10. The control signal received by the communication section 32 includes a sound reproduction signal, a force sensation control signal, and a tactile control signal. The sound reproduction signal outputs a sound from the speakers 17. The force sensation control signal drives the force sensation presentation sections 34. The tactile control signal drives the tactile presentation sections 36. The force sensation control signal may include control signals that independently drive the first force sensation presentation section 34a and the second force sensation presentation section 34b. The tactile control signal may include control signals that independently drive the first tactile presentation section 36a and the second tactile presentation section 36b. The control section 30 controls the operation of each component element according to the control signal.

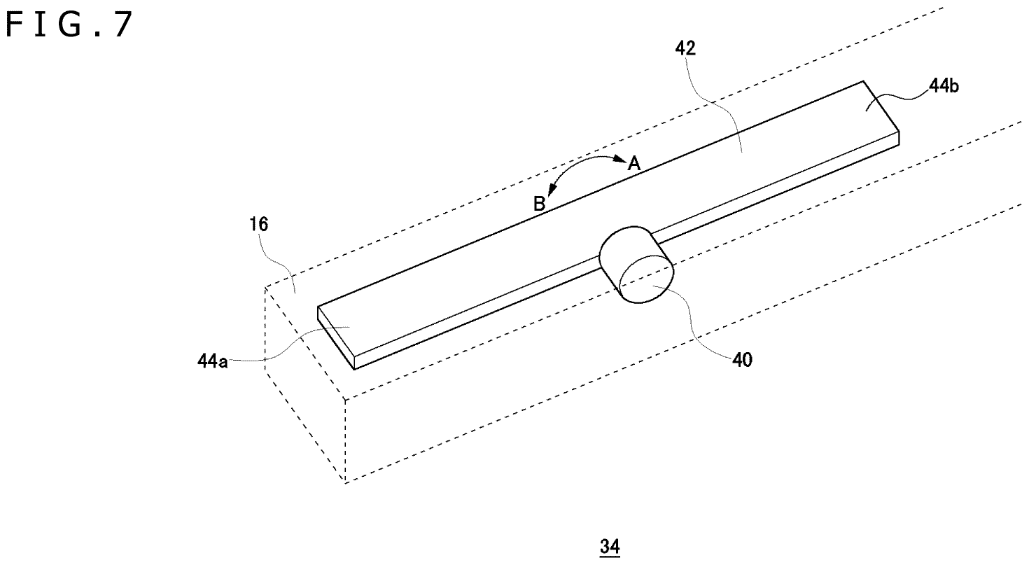

FIG. 7 is a schematic diagram illustrating a structure of one of the force sensation presentation sections 34. The force sensation presentation sections 34 are provided inside the housings for the extended sections 16, and each include an actuator 40 and a movable part 42. The movable part 42 is moved by the actuator 40. In the illustrated example, the actuator 40 includes an electric motor and a speed reducer, and the control section 30 controls the actuator 40 according to the force sensation control signal received by the communication section 32.

The control section 30 rotationally drives the actuator 40 to apply a rotational force to the movable part 42. The movable part 42 is a plate-like member having a first end 44a and a second end 44b. The first end 44a is disposed toward the front end (open end) of each of the extended sections 16, and the second end 44b is disposed toward the rear end of each of the extended sections 16.

The force sensation presentation sections 34 according to the embodiment are each configured such that the actuator 40 applies a rotational force to the movable part 42, brings the body of the user into indirect or direct contact with either the first end 44a or the second end 44b, and applies a force to the user to present the user with a force sensation. Specifically, the force sensation presentation sections 34 each apply a rotational force to the movable part 42 and bring either the first end 44a or the second end 44b into contact with the inner surface of the housing. This results in transmitting a strong impact force or a pressing force to the user's body via the housing and generating a reaction force in the bones and the muscles of the user. As described above, the force sensation presentation sections 34 according to the embodiment each cause the user to feel the reaction force when the first end 44a or the second end 44b comes into indirect or direct contact with the user's body. The force sensation presented by the force sensation presentation sections 34 is different from a vibratory stimulus presented by the tactile presentation sections 36.

The lower sides (the side coming into contact with the surface of the user's body) of the housings for the extended sections 16 are each configured such that the force applied by the movable part 42 is efficiently transmitted to the surface of the user's body. For example, in each of the housings for the extended sections 16, it is preferable that at least a portion contacted by the first end 44a or the second end 44b, that is, a portion to which the first end 44a and the second end 44b apply an impact force and/or a pressing force, be formed by aluminum or other hard materials having excellent force transmission characteristics, and that the rotational force applied to the movable part 42 be efficiently transmitted to the surface of the user's body. It should be noted that, in each of the housings, the area not contacted by the first end 44a and the second end 44b may be formed by a resin material while only the area contacted by the first end 44a or the second end 44b is formed by a material that easily transmits a force. It should also be noted that an opening may be formed in each of the housings to bring the first end 44a and/or the second end 44b into direct contact with the user's body surface without going through the housings.

In a usage mode of the force sensation presentation device 10, it is preferable that the length of the main body 11 be adjusted to position the first end 44a disposed toward the front end of each of the extended sections 16 in such a manner as to match the user's clavicle. In the force sensation presentation device 10, the length between the first extended section 16a and the first overhang section 15a is adjusted by the first adjustment section 18a such that the first end 44a of the movable part 42 disposed in the first extended section 16a applies a force to the user's right clavicle. Similarly, the length between the second extended section 16b and the second overhang section 15b is adjusted by the second adjustment section 18b such that the first end 44a of the movable part 42 disposed in the second extended section 16b applies a force to the user's left clavicle. Disposing the first adjustment section 18a and the second adjustment section 18b on the left and right sides makes it easy to align the first ends 44a of the left and right movable parts 42 with the positions of the clavicles, respectively.

The inventor of the present invention has stricken various parts of the human body, and investigated the resulting sensitivity. As a result of the investigations, the inventor has found that, as regards the upper body, the users are most likely to feel an impact force when the clavicles are stricken, as compared to a case where the muscles are stricken. Therefore, it is preferable that the adjustment mechanism 18 according to the embodiment be able to adjust the length of the main body 11 in such a manner as to place the first ends 44a of the movable parts 42 at the positions of the user's clavicles. Allowing the control section 30 to drive the actuator 40 to strike the user's clavicles with the first ends 44a presents the user with the feeling of receiving a strong impact in synchronization with the behavior of a player character in the game.

The second end 44b, which is disposed toward the rear end of each of the extended sections 16, may be disposed on the shoulder of the user and controlled by the control section 30 to apply pressure to the muscles of the shoulder. The following describes, for example, how the force sensation presentation sections 34 are controlled when the user's player character shoots a gun in a game. When the player character starts pulling the trigger of the gun, the control section 30 controls the actuator 40 to gradually increase the torque applied in a rotation direction A. As a result, the second end 44b applies pressure to the user's shoulder, and the applied pressure is controlled to increase gradually until just before shooting. When the player character finishes pulling the trigger and fires a bullet, the control section 30 controls the actuator 40 to rotate the movable part 42 in a rotation direction B at high speed. This causes the first end 44a of the movable part 42 to strike the user's clavicles. Owing to the above-described series of force sensation presentations, the user is provided with an experience that is synchronized with the behavior of the player character, and can feel immersed in the game. The force sensation presentation sections 34 in the embodiment are each able to present the force sensation at two points of action by using one movable part 42. This results in providing the user with different kinds of experiences.

The tactile presentation sections 36 each include a voice coil motor (VCM), an eccentric motor, or other vibration devices for generating a tactile vibration, and presents the tactile sensation to the user. For example, the tactile presentation sections 36 may each be provided near the first end 44a of the movable part 42 to transmit the tactile vibration to the clavicles. The force sensation presentation device 10 according to the embodiment is able to present the user with both the force sensation and the tactile sensation. This makes it possible to provide the user with a rich game experience.

The present invention has been described above on the basis of a plurality of embodiments. A person skilled in the art will understand that the foregoing embodiment is merely illustrative, that various modifications can be made to the combinations of component elements and processes, and that such modifications are also within the scope of the present invention. In the embodiment, the game system 1 includes the game console 2 that executes the game software. However, the game software may be executed by a cloud server connected to the game system 1 through the Internet. In a case where the game software is executed by the cloud server, the force sensation presentation device 10 may receive a control signal from the cloud server, which is an external device, and may control the operation of each component element according to the control signal.

In the embodiment, the adjustment mechanism 18 includes the first adjustment section 18a, which is able to change the position of the first extended section 16a relative to the base section 12, and the second adjustment section 18b, which is able to change the position of the second extended section 16b relative to the base section 12, and thus makes it possible to independently adjust the relative positions of the first extended section 16a and the second extended section 16b. In a modification, the adjustment mechanism 18 may be disposed on the curved section 14 of the base section 12 in such a manner as to be able to adjust the length of the curved section 14.

The movable part 42 may be configured such that its first and second ends are at the same distance from a rotation axis. Alternatively, however, the first and second ends may be at different distances from the rotation axis. For example, in order to increase the pressing force applied to the muscles of the shoulder by the second end 44b, the distance between the rotation axis and the second end 44b may be made longer than the distance between the rotation axis and the first end 44a.

### INDUSTRIAL APPLICABILITY

The present invention is applicable to a device that is worn around the user's neck to present a force sensation to the user.

### REFERENCE SIGNS LIST

10: Force sensation presentation device
11: Main body
12: Base section
13a: First end
13b: Second end
14: Curved section
15a: First overhang section
15b: Second overhang section
16a: First extended section
16b: Second extended section
17a: First speaker
17b: Second speaker
18: Adjustment mechanism
18a: First adjustment section
18b: Second adjustment section
19: Engaging protrusion
20: Arm
21: Recess
22: Cylindrical body section
30: Control section
32: Communication section
34: Force sensation presentation section
34a: First force sensation presentation section
34b: Second force sensation presentation section
36: Tactile presentation section
36a: First tactile presentation section
36b: Second tactile presentation section
40: Actuator
42: Movable part
44a: First end
44b: Second end

The invention claimed is:

1. A force sensation presentation device that is worn around a neck of a user, the force sensation presentation device comprising:
a communication section that receives a control signal from an external device;
a force sensation presentation section that presents a force sensation to the user wearing the force sensation presentation device and includes an actuator and a movable part, the movable part being driven by the actuator; and
a control section that controls the actuator according to the received control signal.

2. The force sensation presentation device according to claim 1,
wherein the actuator applies a rotational force to the movable part.

3. The force sensation presentation device according to claim 2,
wherein the movable part is a plate-like member having a first end and a second end, and when the first end or the second end comes into contact with the user, a force sensation is presented to the user.

4. The force sensation presentation device according to claim 1, further comprising:
a main body that includes a base section, a first extended section, and a second extended section, the base section having a curved section contacting a back of the user's neck, the first extended section being connected to a first end of the base section, the second extended section being connected to a second end of the base section; and
an adjustment mechanism that is able to adjust a length of the main body.

5. The force sensation presentation device according to claim 4,
wherein the adjustment mechanism includes a first adjustment section and a second adjustment section, the first adjustment section being able to change a position of the first extended section relative to the base section, the second adjustment section being able to change a position of the second extended section relative to the base section.

6. The force sensation presentation device according to claim 4,
wherein the force sensation presentation section is included in each of the first extended section and the second extended section, and
the adjustment mechanism is able to adjust the length of the main body such that the force sensation presentation section applies a force to clavicles of the user.

7. The force sensation presentation device according to claim 1, further comprising:
a tactile presentation section that presents a tactile sensation to the user; and
a speaker.

8. The force sensation presentation device according to claim 1,
wherein the communication section receives a control signal generated by game software.
